(19) United States
(12) Patent Application Publication
(10) Pub. No.: US 2013/0247063 A1
(43) Pub. Date: Sep. 19, 2013

(54) COMPUTING DEVICE AND METHOD FOR MANAGING MEMORY OF VIRTUAL MACHINES

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); KUAN-CHIAO PENG, New Taipei (TW); YEN-HUNG LIN, New Taipei (TW)

(73) Assignee: HON HAI PRECISION INDUSTRY CO., LTD., New Taipei (TW)

(21) Appl. No.: 13/757,879

(22) Filed: Feb. 4, 2013

(30) Foreign Application Priority Data
Mar. 16, 2012 (TW) 101108978

(51) Int. Cl. G06F 9/50

(52) U.S. Cl. CPC G06F 9/5016
USPC 718/104

(57) ABSTRACT

In a method for managing memory of virtual machines in a computing device, a user request for allocating a specified amount of memory of the computing device to a virtual machine is received. If the available memory of the computing device is less than the specified amount of memory, total idle memory of all the virtual machines in the computing device is calculated. If the total idle memory is less than the specified amount of memory, an average release memory of the virtual machines in the computing device is calculated. The idle memory of the virtual machines is released according to the average release memory.

### BACKGROUND

1. Technical Field

Embodiments of the present disclosure relate to virtual machine technology, and particularly to a computing device and method for managing memory of virtual machines in the computing device.

2. Description of Related Art

In virtual machine technology, a plurality of virtual machines (VMs) may be installed in a computing device. Each virtual machine is allocated a certain amount of memory of the computing device based on the projected requirements of the VM. As such, the number of VMs is limited by the sum of total memory allocated to each installed VM and the minimum memory for the computing device. However, memory requirements for VMs may change, for example, a VM may need less memory to handle less users or applications, etc., and this situation may allow more VMs to be added to the computing device. However, to make adjustment to the memory allocated to each VM, the VMs must be shut-down and changes made through the virtualization application. This is tedious and inconvenient.

Therefore, there is room for improvement in the art.

### BRIEF DESCRIPTION OF THE DRAWINGS

FIG. 1 is one embodiment of an application of a computing device.

FIG. 2 is a block diagram of one embodiment of function modules of a memory management system in FIG. 1.

FIG. 3 is a flowchart of one embodiment of a method for managing memory of virtual machines in the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

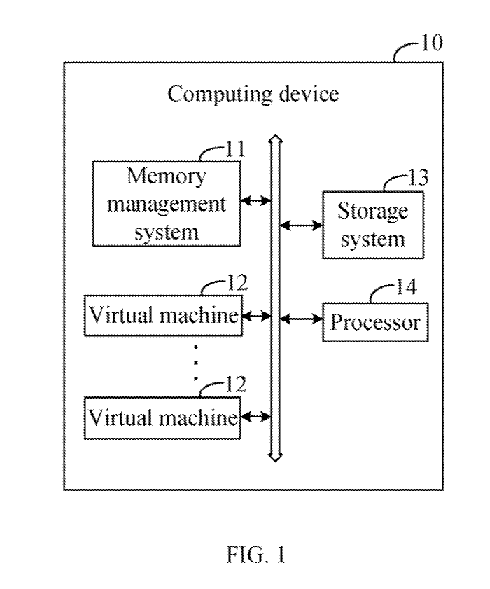

FIG. 1 is one embodiment of an application of a computing device 10 including a memory management system 11. A plurality of virtual machines 12 are installed in the computing device 10 to provide services (e.g., computing services) to users. The computing device 10 further includes a storage system 13 and at least one processor 14. The storage system 13 includes memory (e.g., dynamic random access memory) and secondary storage (e.g., hard disk drive). Each virtual machine occupies some amount of the memory of the computing device 10. The memory management system 11 is used to release idle memory of the virtual machines 12 when available memory of the computing device 10 is insufficient.

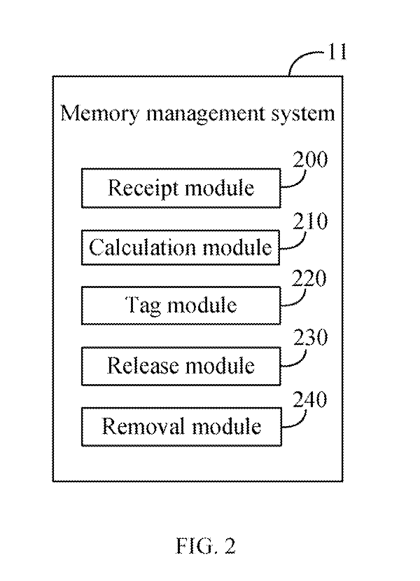

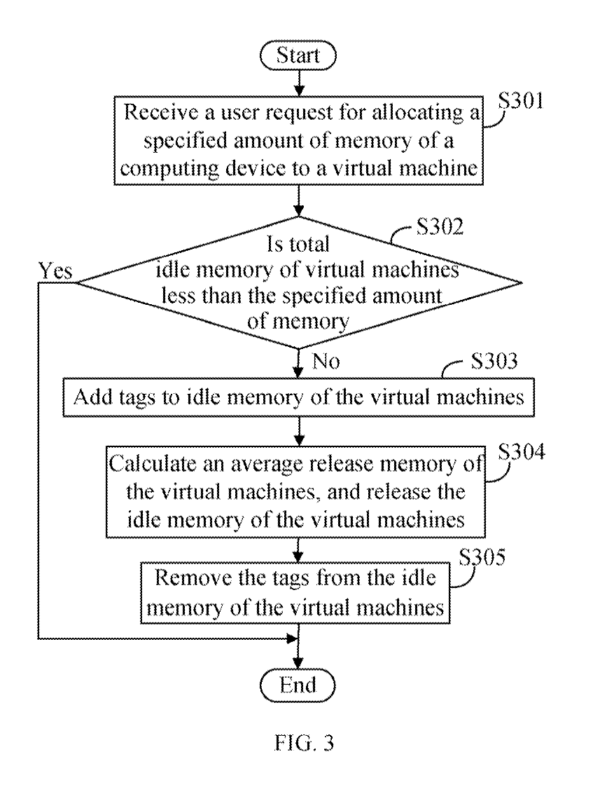

FIG. 2 is a block diagram of one embodiment of function modules of the memory management system 11 in FIG. 1. The memory management system 11 includes a receipt module 200, a calculation module 210, a tag module 220, a release module 230, and a removal module 240. The modules 200-240 may comprise computerized code in the form of one or more programs that are stored in the storage system 13. The computerized code includes instructions that are executed by the at least one processor 14, to provide the aforementioned functions of the memory management system 11. A detailed description of the functions of the modules 200-240 is given in reference to FIG. 3.

FIG. 3 is a flowchart of one embodiment of a memory release method for managing memory of the virtual machines 12 using the computing device 10 of FIG. 1. Depending on the embodiment, additional steps may be added, others removed, and the ordering of the steps may be changed.

In step S301, the receipt module 200 receives a user request for allocating a specified amount of memory of the computing device 10 to a virtual machine 12. The virtual machine 12 may be a new virtual machine to be installed in the computing device 10 or an existing virtual machine in the computing device 10. In one example, three virtual machines 12 denoted as VM1, and VM2, VM3 are installed in the computing device 10. When a new virtual machine VM4 is required to be installed in the computing device 10, a specified amount of memory (e.g., 3 GB) is specified to VM4. The user request may be submitted from a client computer connected to the computing device 10.

If available memory of the computing device 10 is less than the specified amount of memory, in step S302, the calculation module 210 calculates total idle memory of all the virtual machines 12 in the computing device 10, and determines whether the total idle memory is less than the specified amount of memory. In one example, 3 GB memory is specified to allocate to VM4, and VM1 includes 1 GB idle memory, VM2 includes 2 GB idle memory, and VM3 includes 1 GB idle memory. Therefore, total idle memory of VM1, VM2, and VM3 is 4 GB, which is greater than the specified amount of memory. If the total idle memory of the virtual machines 12 is less than the specified amount of memory, the process ends. In one embodiment, each virtual machine 12 in the computing device 10 includes a memory monitor, which detects idle memory of the virtual machine 12.

If the total idle memory of the virtual machines 12 is equal to or greater than the specified amount of memory, in step S303, the tag module 220 adds tags to the idle memory of the virtual machines 12, to prevent subsequent access to the idle memory by the virtual machine 12 which possesses the idle memory. In one embodiment, memory of each virtual machine 12 in the computing device 10 consists of fixed-length blocks. The tag module 220 attaches the tags to idle blocks of the virtual machine 12.

In step S304, the release module 230 calculates an average release memory of the virtual machines 12 in the computing device 10, and releases the idle memory of the virtual machines 12 according to the average release memory. The average release memory of the virtual machines 12 is calculated by dividing the specified amount of memory by the number of the virtual machines 12. As mentioned above, VM1, VM2 and VM3 are installed in the computing device 10 and VM1 includes 1 GB idle memory, VM2 includes 2 GB idle memory, and VM3 includes 1 GB idle memory. 3 GB memory is required to be allocated to the new virtual machine VM4. Therefore, the average release memory of the three virtual machines 12 is 1 GB (i.e., 3 GB/3). The release module 230 releases 1 GB idle memory from each of VM1, VM2, and VM3. If a first virtual machine includes less idle memory than the average release memory while a second virtual machine includes more idle memory than the average release memory, the release module 230 may release less idle memory than the average release memory from the first virtual machine, and release more idle memory than the average release memory from the second virtual machine. For example, if VM 1 includes 0.5 GB idle memory and VM 2 includes 2 GB idle memory, the release module 230 releases 0.5 GB idle memory from VM1 and releases 1.5 GB idle memory from VM2.

In step S305, the removal module 240 removes the tags from the idle memory of the virtual machines 12 in the computing device 10. After the tags of the idle memory have been removed, remaining idle memory is accessible for the virtual machines 12.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for managing memory of virtual machines in a computing device being executed by a processor of the computing device, the method comprising:
receiving a user request for allocating a specified amount of memory of the computing device to a virtual machine;
calculating total idle memory of the virtual machines in the computing device in response that the available memory of the computing device is less than the specified amount of memory, and determining whether the total idle memory of the virtual machines in the computing device is less than the specified amount of memory; and calculating an average release memory of the virtual machines in the computing device in response that the total idle memory of the virtual machines is equal to or greater than the specified amount of memory, and releasing the idle memory of the virtual machines according to the average release memory.

2. The method of claim 1, further comprising:
adding tags to the idle memory of the virtual machines in the computing device before the idle memory of the virtual machines is released; and
removing the tags from the idle memory of the virtual machines in the computing device after the idle memory of the virtual machines is released.

3. The method of claim 1, wherein each virtual machine in the computing device comprises a memory monitor that detects idle memory of the virtual machine.

4. The method of claim 1, wherein memory of each virtual machine in the computing device comprises fixed-length blocks, and the tags are added to idle blocks of the virtual machines.

5. The method of claim 1, wherein the average release memory of the virtual machines in the computing device is calculated by dividing the specified amount of memory by a number of the virtual machines.

6. The method of claim 1, wherein: on condition that idle memory of a first virtual machine is less than the average release memory and idle memory of a second virtual machine is more than the average release memory, less idle memory than the average release memory is released from the first virtual machine, and more idle memory than the average release memory is released from the second virtual machine.

7. A computing device, comprising:
a storage system;
at least one processor; and
a memory management system comprising one or more programs that are stored in the storage system and executed by the at least one processor, the one or more programs comprising instructions to:
receive a user request for allocating a specified amount of memory of the computing device to a virtual machine;
calculate total idle memory of virtual machines in the computing device in response that the available memory of the computing device is less than the specified amount of memory, and determine whether the total idle memory of the virtual machines in the computing device is less than the specified amount of memory;
add tags to the idle memory of the virtual machines in the computing device in response that the total idle memory of the virtual machines is equal to or greater than the specified amount of memory;
calculate an average release memory of the virtual machines in the computing device, and release the idle memory of the virtual machines according to the average release memory; and
remove the tags from the idle memory of the virtual machines in the computing device.

8. The computing device of claim 7, wherein the one or more programs further comprise instructions to:
add tags to the idle memory of the virtual machines in the computing device before the idle memory of the virtual machines is released; and
remove the tags from the idle memory of the virtual machines in the computing device after the idle memory of the virtual machines is released.

9. The computing device of claim 7, wherein each virtual machine in the computing device comprises a memory monitor that detects idle memory of the virtual machine.

10. The computing device of claim 7, wherein memory of each virtual machine in the computing device comprises fixed-length blocks, and the tags are added to idle blocks of the virtual machines.

11. The computing device of claim 7, wherein the average release memory of the virtual machines in computing device is calculated by dividing the specified amount of memory by a number of the virtual machines.

12. The computing device of claim 7, wherein: on condition that idle memory of a first virtual machine is less than the average release memory and idle memory of a second virtual machine is more than the average release memory, less idle memory than the average release memory is released from the first virtual machine, and more idle memory than the average release memory is released from the second virtual machine.

13. A non-transitory storage medium storing a set of instructions, the set of instructions capable of being executed by a processor of a computing device to implement a method for managing memory of virtual machines in a computing device, the method comprising:
receiving a user request for allocating a specified amount of memory of the computing device to a virtual machine;
calculating total idle memory of the virtual machines in the computing device in response that the available memory of the computing device is less than the specified amount of memory, and determining whether the total idle memory of the virtual machines in the computing device is less than the specified amount of memory;
adding tags to the idle memory of the virtual machines in the computing device in response that the total idle memory of the virtual machines is equal to or greater than the specified amount of memory;
calculating an average release memory of the virtual machines in the computing device, and releasing the idle memory of the virtual machines according to the average release memory; and
removing the tags from the idle memory of the virtual machines in the computing device.

14. The non-transitory storage medium of claim 13, wherein the method further comprising:
adding tags to the idle memory of the virtual machines in the computing device before the idle memory of the virtual machines is released; and
removing the tags from the idle memory of the virtual machines in the computing device after the idle memory of the virtual machines is released.

15. The non-transitory storage medium of claim 13, wherein each virtual machine in the computing device comprises a memory monitor that detects idle memory of the virtual machine.

16. The non-transitory storage medium of claim 13, wherein memory of each virtual machine in the computing device comprises fixed-length blocks, and the tags are added to blocks of the idle memory of the virtual machines.

17. The non-transitory storage medium of claim 13, wherein the average release memory of the virtual machines in computing device is calculated by dividing the specified amount of memory by a number of the virtual machines.

18. The non-transitory storage medium of claim 13, wherein: on condition that idle memory of a first virtual machine is less than the average release memory and idle memory of a second virtual machine is more than the average release memory, less idle memory than the average release memory is released from the first virtual machine, and more idle memory than the average release memory is released from the second virtual machine.
